(19) United States
(12) Patent Application Publication
(10) Pub. No.: US 2005/0089002 A1
(43) Pub. Date: Apr. 28, 2005

(54) Method for wireless local area network communication in distributed coordination function mode

(75) Inventors: Se-young Shin, Suwon-si (KR); Kyung-ik Cho, Suwon-si (KR); Seung-seop Shim, Anyang-si (KR); Suk-jin Yun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/974,891

(22) Filed: Oct. 28, 2004

(30) Foreign Application Priority Data
Oct. 28, 2003 (KR) 10-2003-0075660

(51) Int. Cl. H04B 7/212

(52) U.S. Cl. 370/338

(57) ABSTRACT

Provided is a wireless local area network (LAN) communication method in the Distributed Coordination Function mode. The method includes (a) setting a predetermined back-off according to the characteristic of data transmitted, and (b) transmitting data if a channel is available at the end of the back-off, and updating the back-off using residual back-off when a channel is used during the back-off. The data transmission throughput can be increased by reducing the back-off according to the characteristic of data to be transmitted. An increase in the data transmission throughput is particularly effective in transmitting real-time data.

This invention is based on and claims priority from Korean Patent Application No. 10-2003-0075660 filed on Oct. 28, 2003 in the Korean Intellectual Property Office, the disclosure of which is incorporated herein by reference.

### BACKGROUND OF THE INVENTION

1. Field of the Invention

The present invention relates to a wireless local area network (LAN) communication method, and more particularly, to a wireless LAN communication method that improves a Distributed Coordination Function (DCF).

2. Description of the Related Art

In general, a wireless LAN is a short-distance wireless network compliant with an IEEE 802.11 standard. Wireless LAN standards generally approved or still under development include: 802.11b, which provides a data transfer rate of up to 11 megabits per second (Mbps) in the 2.4 gigahertz (GHz) frequency band using Frequency Hopping Spread Spectrum (FHSS), Direct Sequence Spread Spectrum (DSSS), or Infrared Rays (IR); 802.11a, which operates in the 5 GHz frequency band and delivers a data transfer rate of up to 54 Mbps based on an Orthogonal Frequency Division Multiplexing (OFDM) scheme; 802.11e, which is devised to improve Quality of Service (QoS); 802.11f, which is designed for an Inter-Access Point Protocol (IAPP); 802.11g that operates in the 2.4 GHz frequency band and offers a data transfer rate of up to 54 Mbps using an OFDM scheme; 802.11h, which provides Transmit Power Control (TPC) and Dynamic Frequency Selection (DFS) mechanisms; and 802.11i, which beefs up security. In addition, an 802.11 Study Group (5 GHz Globalization Special Group; 5GSG) has been formed to address harmonization of the 5 GHz frequency range, and a 902.11 Wireless LAN Next Generation (WNG) standing committee is developing next-generation wireless LAN technology.

Wireless LANs generally use the 2.4-2.5 GHz or 5 GHz Industrial/Scientific/Medical (ISM) bands authorized for wireless LAN applications. The ISM bands are the frequency bands designated for use by industrial, scientific, or medical equipment, and can be used without permission where the emitted power is below a predetermined level.

The IEEE 802.11 network is built around a Basic Service Set (BSS), which is a group of stations communicating with one another. There are two specific kinds of BSS's: an independent BSS (IBSS) where stations directly communicate with one another without an access point (AP), and an infrastructure BSS where an AP is used for all communication.

FIG. 1 shows a typical communication environment of a wireless LAN.

As shown in FIG. 1, the wireless LAN allows stations within a predetermined distance of one another to wirelessly send and receive data to and from one another without the need for floor wiring similar to that of wired Ethernet. Thus, within the wireless LAN, stations wirelessly communicate with one another so they are free to move from place to place. As depicted in the drawing, infrastructure BSS's may be combined with each other to form an Extended Service Set (ESS). All stations within the infrastructure BSS must communicate with one another through an AP. For example, when a first station wishes to send a frame to a second station, the frame is sent first to the AP, and then the AP delivers the frame to the second station. Upon receipt of the frame, the second station transmits an Ack frame confirming the receipt of the frame to the first station through the AP. Thus, in the infrastructure BSS, frame exchanges take two hops. A communication scheme in the infrastructure BSS is mainly divided into two modes: a Distributed Coordination Function (DCF) mode and a Point Coordination Function (PCF) mode. The PCF mode allows a special station called a Point Coordinator (PC), which mainly acts as an AP, to transfer data between stations without contention. The PCF mode advantageously has no contention for media, but in fact, this mode has hardly been embodied because polling and response methods for it are inefficient.

In the independent BSS, access to a wireless medium occurs in DCF mode. The DCF mode is based on Carrier Sense Multiple Access with Collision Avoidance (CSMA/CA) for high transmission efficiency unlike the wired Ethernet using Carrier Sense Multiple Access with Collision Detection (CSMA/CD). According to the CSMA/CA mechanism, first, it is checked whether a channel is idle, and if the channel is idle, data transfer occurs. Meanwhile, the 802.11 DCF protocol adopts a scheme in which a sender transmits a frame after waiting a predetermined back-off, even if the channel is idle, in order to avoid frame collision between stations together with CSMA/CA.

FIG. 2 is a diagram showing a Random Back Off process performed in the DCF mode.

Prior to transmission of data, it is checked whether a channel is idle or not using a Carrier Sense Multiple Access with Collision Detection (CSMA/CD) mechanism. In the DCF mode, if it is determined that a channel is idle, the station waits for a distributed interframe space (DIFS) before transmission of data. At the end of the DIFS, the station has a predetermined back-off for collision avoidance among stations. In the following description, a channel being idle suggests that the channel is in a state in which it is capable of performing a back-off operation for data transmission, and substantially the same state occurs at the end of a DIFS after a frame transmission is made by another station.

A back-off mechanism performed in a case where a channel is idle will now be briefly described. In order for a station to transmit data, the station randomly selects a predetermined back-off duration from a contention window (CW). Then, it is checked whether a channel is idle or not. If the channel is idle, the station waits for the back-off duration to end. However, if the channel is used by any other station during the back-off duration, the station stops waiting. When the channel becomes idle again, the station transmits data after the residual back-off period is elapsed. If two or more stations having the same back-off happen to transmit data simultaneously, data transmission fails and the stations have to retransmit the data. When data needs to be retransmitted, the size of a CW, from which back-off durations are selected, drastically increases, which will be described below with reference to FIG. 3.

FIG. 3 shows an exponential increase of a CW.

First, the size of the CW is 7, i.e., the number of time slots is 7. The first time data retransmission occurs, the size of the CW is 15, which increases to 31, then 63 . . . . In this case, the back-off of the station is determined by Equation 1:
Tb=R(CW)×St [Equation 1]
CW=2³⁺ⁱ−1 (i=0, 1, 2, 3, . . . )
where Tb indicates the back-off of a station, St indicates the duration of one time slot, CW indicates the number of time slots included in a CW, i indicates retransmission frequency, and R(CW) indicates a fixed number selected randomly between 0 and CW. Meanwhile, the CW is not increased indefinitely. If it exceeds a predetermined maximum value, it is fixed at the maximum value and does not increase any more. FIG. 3 shows that the maximum value is 255, for example. In a Direct Sequence Spread Spectrum (DSSS) mechanism, the maximum value of CW is generally 1023.

While the above-described retransmission mechanism is advantageously used in avoiding a collision between stations, the size of a back-off may increase exponentially when retransmission occurs, decreasing the efficiency of data transmission. In particular, in a station that transmits real-time data, for example, a station that offers a multimedia motion-picture streaming service, Quality of Service (QoS) may not be ensured, because an exponential increase in back-off due to retransmission can cause delay of packet communication and jitter. Therefore, a mechanism that ensures QoS is needed.

The IEEE 802.11e MAC offers a variety of mechanisms to ensure QoS, and one of them is a Block Acknowledge (Block Ack) mechanism, which will now be described with reference to FIG. 4.

The Block Ack mechanism can be largely divided into three processes: (a) a set-up process, (b) a data transmission and block acknowledge (Block Ack) process, and (c) an end process. In the set-up process, first, it is checked whether or not it is possible for a Transmitting station to use the Block Ack mechanism with respect to a receiving station, and a request for an ADD Block Ack (ADDBA) is made.

Then, the receiving station informs the transmitting station of the Block Ack type and the number of buffers while making the ADDBA response. At this time, the receiving station may refuse the ADDBA request.

When the set-up process is completed, the transmitting station transmits frames within the range of the number of buffers in a Short Inter Frame Space (SIFS). Here, a sequence number of data transmitted for the first time is provided in order to indicate that the transmission of data frames has started. The transmitting station transmits a Block Ack request frame to the receiving station to check whether or not the data frames have been transmitted normally. The receiving station sends to the transmitting station the Block Ack including acknowledge response information. These processes can be repeated several times.

After the data transmission and Block Ack process is completed, the procedure goes to the end process. When the transmitting station has no more data to be transmitted, it requests the receiving station to send a DEL Block Ack (DELBA).

According to the 802.11e MAC mechanism, QoS can be ensured. However, when there are two or more stations, channels may be highly likely to be occupied by a single station. In addition, in order to implement the Block Ack mechanism, it is necessary to perform the set-up or end process, which may result in unnecessary consumption of channel transmission capacity in a case where real-time data transmission is made intermittently, rather than continuously.

For the reasons described above, a DCF mechanism that can enhance transmission efficiency while ensuring a predetermined level of QoS according to the type of data to be transmitted is highly desirable.

### SUMMARY OF THE INVENTION

To solve the above-described problems, it is an object of the present invention to provide a wireless LAN communication method having the DCF mechanism, which ensures a predetermined level of QoS according to the type of data to be transmitted, and has excellent transmission efficiency.

To solve the above-described problems, a wireless local area network (LAN) communication method according to an exemplary embodiment of the present invention includes (a) setting a predetermined back-off according to the characteristic of data transmitted; and (b) transmitting data when a channel is available at the end of the back-off, and updating the back-off using residual back-off when a channel is used during the back-off. In step (a), the back-off is set using information on either the type of data transmitted or a required bandwidth. Also, in step (a), either information on the type of data or information on a required bandwidth may be used. In this case, different types of data have different equations for determining a back-off, and the information on the required bandwidth is preferably used in the equations.

Preferably, the characteristic of data transmitted is a required bandwidth for transmission and step (b) further comprises determining a unit size of data to be transmitted according to the size of the required bandwidth. Here, the unit size of data is preferably in proportion to the required bandwidth. Also, the number of frames transmitted at one time is preferably determined by the unit size of data. When the number of frames transmitted at one time is at least two, the time taken to transmit all the frames may be determined through a network allocation vector (NAV).

To solve the above-described problems, a wireless LAN communication method according to another exemplary embodiment of the present invention includes (a) determining a unit size of data transmitted according to a required bandwidth for transmission, and (b) transmitting data corresponding to the unit size of data determined in step (a) when a channel is available at the end of a predetermined back-off, and updating the back-off using residual back-off when a channel is used during the back-off.

The unit size of data is preferably in proportion to the required bandwidth, and the number of frames transmitted at one time is preferably determined by the unit size of data. When the number of frames transmitted at one time is at least two, the time taken to transmit all the frames may be determined through a network allocation vector (NAV).

### BRIEF DESCRIPTION OF THE DRAWINGS

The above and other features and advantages of the present invention will become more apparent by describing in detail exemplary embodiments thereof with reference to the attached drawings in which:

FIG. 1 shows a typical communication environment of a wireless local area network (LAN);

FIG. 2 is a diagram showing the process of a Random Back-Off in a Distributed Coordination Function (DCF) mode;

FIG. 3 shows an exponential increase of a Contention Window (CW);

FIG. 4 is a sequence diagram showing a Block Acknowledge (Block Ack) mechanism according to the IEEE 802.11e standard;

FIG. 5 is a flowchart showing a method of transmitting real-time data according to an embodiment of the present invention;

FIG. 6 is a flowchart showing a method used by a station in transmitting ordinary data according to an embodiment of the present invention;

FIG. 7 is a diagram showing a structure of the IEEE 802.11 MAC frame;

FIG. 8 is a table showing the type and subtype of the IEEE 802.11 MAC frame; and

FIGS. 9A through 9D show various methods of transmitting frames of a data block size.

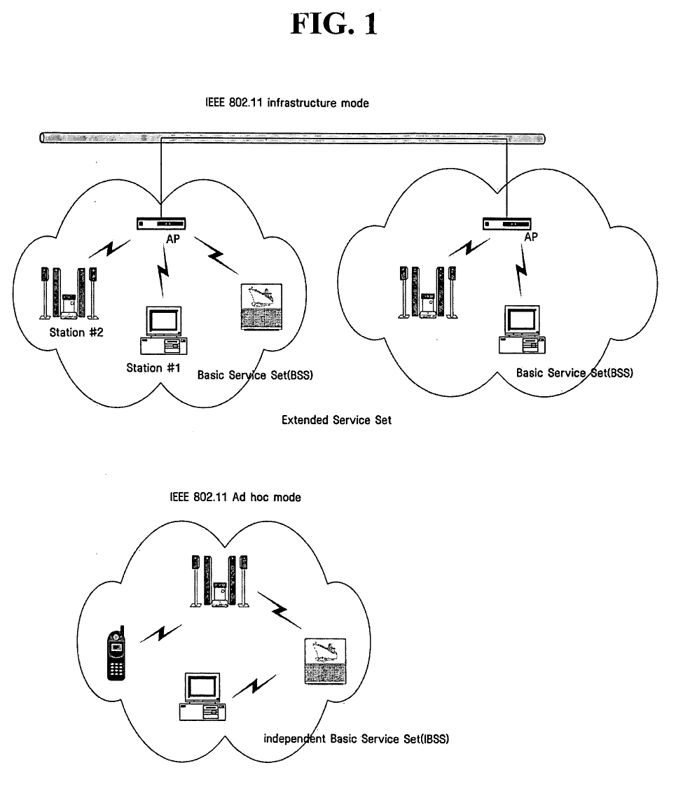

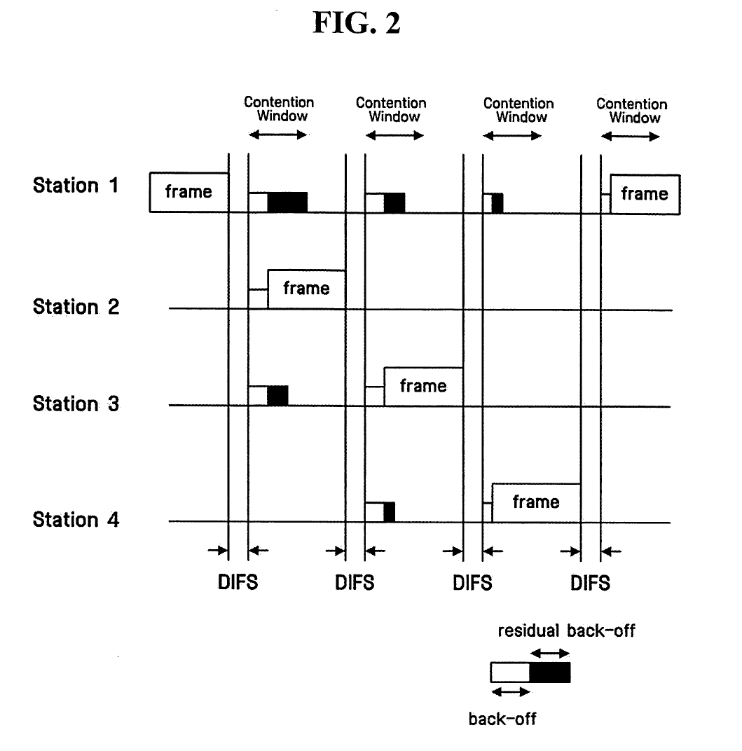

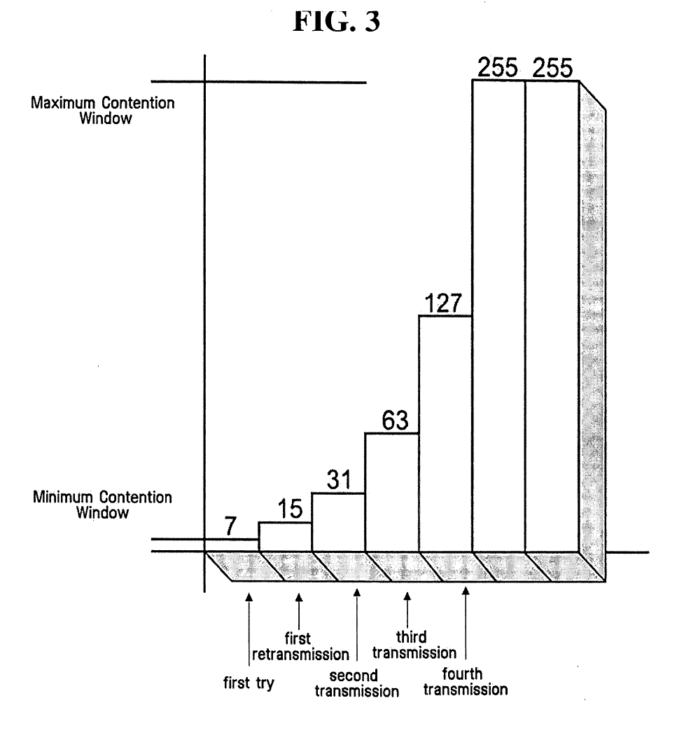

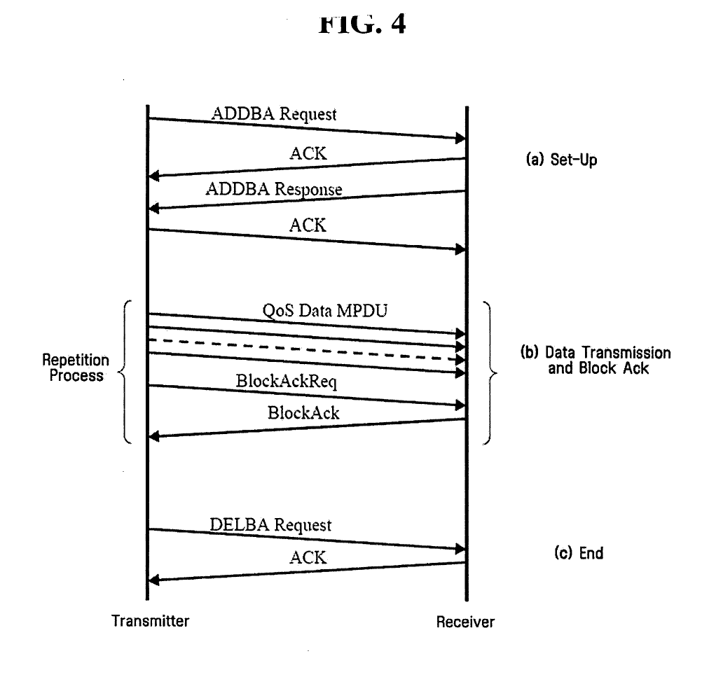

### DETAILED DESCRIPTION OF THE INVENTION

The present invention will now be described more fully with reference to the accompanying drawings, in which an exemplary embodiment of the invention is shown.

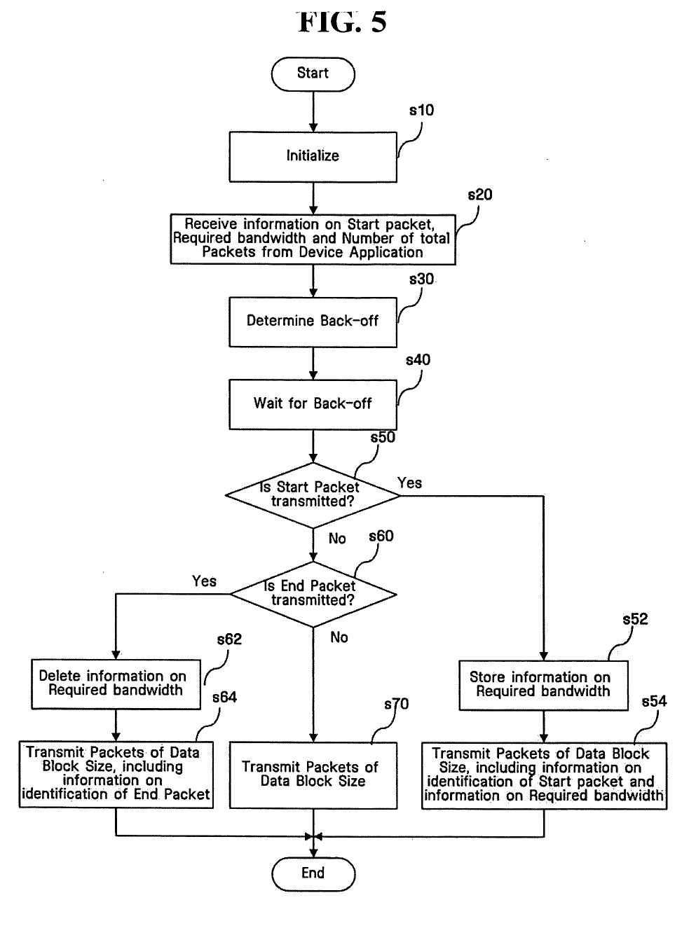

FIG. 5 is a flowchart showing a method used by a station to transmit real-time data according to an embodiment of the present invention.

In order to transmit real-time data, a station must initialize a MAC in step s10. After the MAC is initialized, information on start, a required bandwidth, and the total number of packets of a file to be transmitted is received from a device application in step s20. Data is transmitted in a real-time mode, and the information on the required bandwidth has already been received from the device application. Thus, in step s30, it is possible to determine a modified back-off according to the present invention using the real-time data and the determined information. The determining of a back-off will later be described. It is checked whether a channel is idle or not, and if the channel is idle, the station waits for a time of back-off in step s40. After the back-off is elapsed, followed by transmitting data packet loading frames, on the one hand, identical packets can be simultaneously transmitted. On the other hand, a start packet loading frame and an end packet loading frame can be separately transmitted. Accordingly, in step s50, it is checked whether a pertinent frame to be transmitted is a start packet loading frame or not. If yes, the information on the required bandwidth received from the device application is stored to be used in calculation of a back-off of a subsequent frame in step s52. The start packet loading frame is then transmitted in step s54. Here, the frame includes information required for identification of a start frame and information on the required bandwidth.

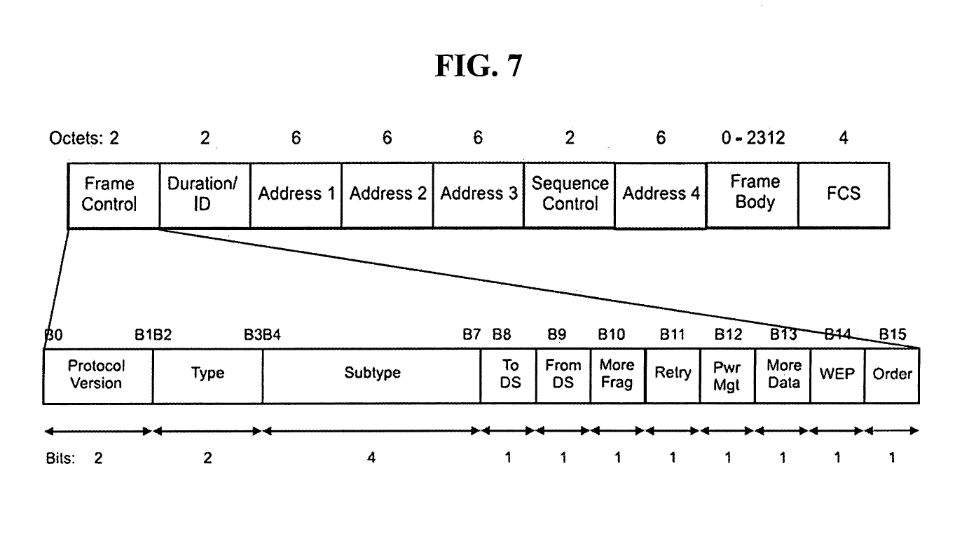

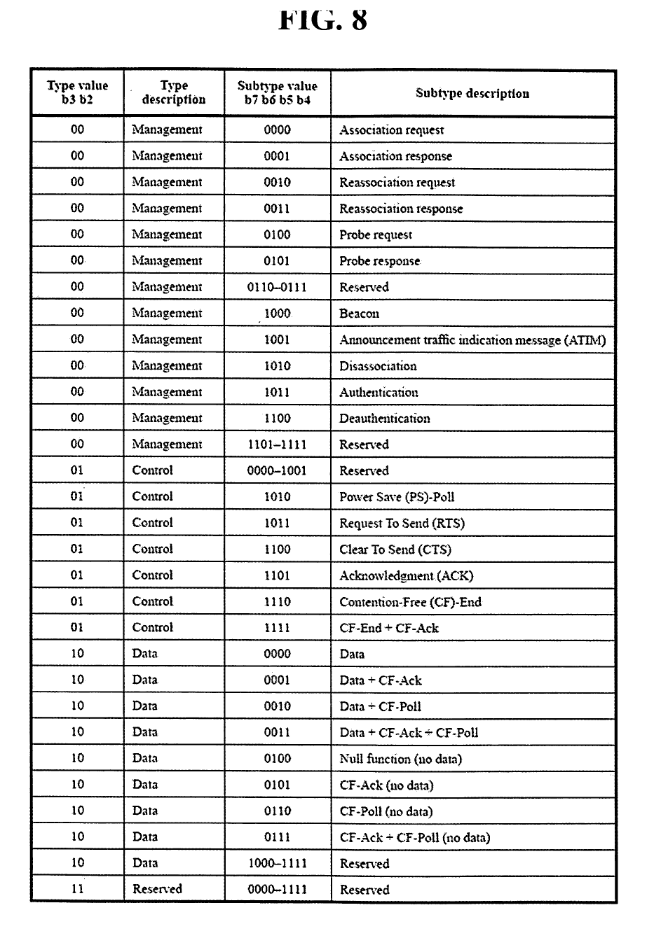

Meanwhile, the frame is transmitted in a new data frame format that can be recognized by all the stations, so that the data information including the type or required bandwidth of data being transmitted by the present station can be used by other stations when they calculate their back-off. The new data frame format will later be described with reference to FIGS. 7 and 8.

In data transmission, the quantity of data that can be transmitted during one bout of contention, which is called a data block size, may vary depending on the required bandwidth.

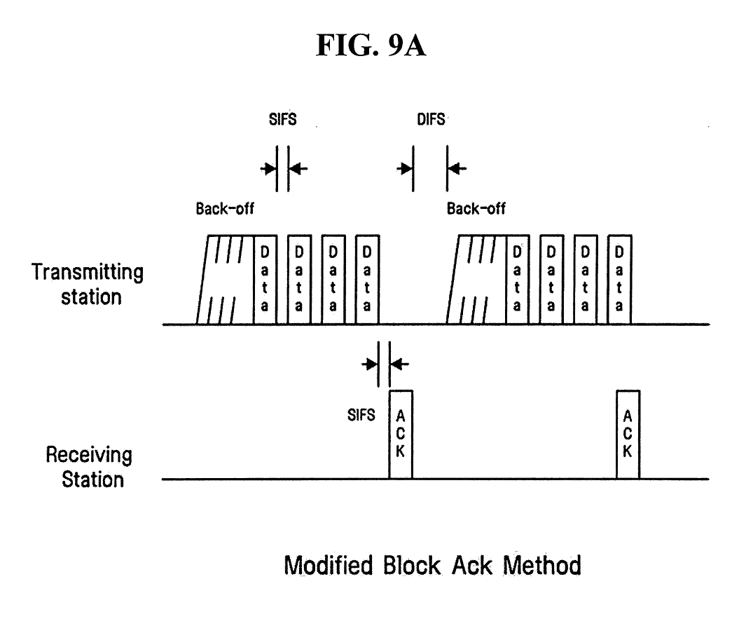

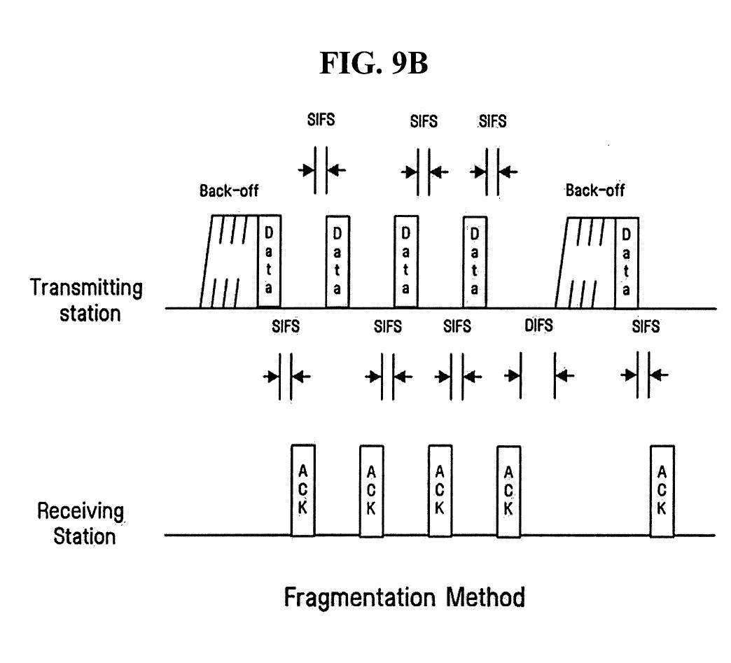

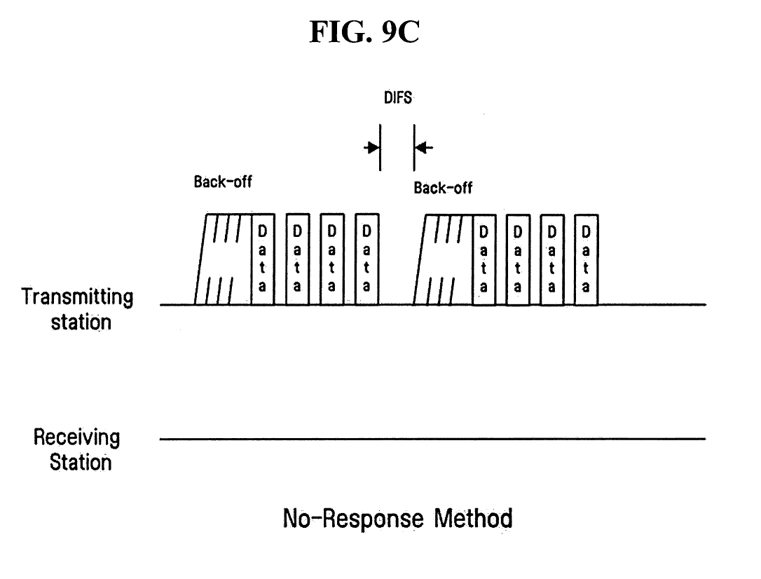

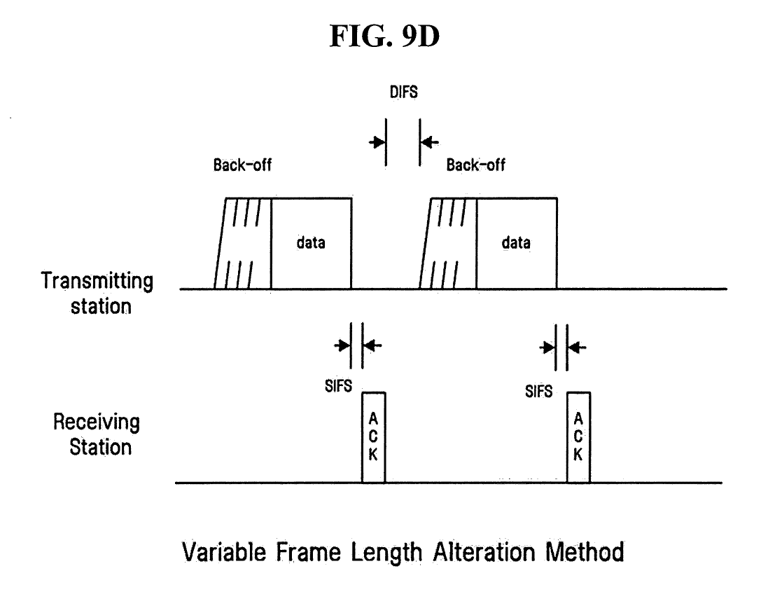

A method of transmitting a data of a data block size during one bout of contention and a method of determining the data block size will later be described with reference to FIG. 9.

When the pertinent frame is not a start packet loading frame, in step s60, it is checked whether it is an end packet loading frame or not. If yes, the MAC deletes the information on the required bandwidth, which has been previously stored, enabling a next file to be transmitted using new information on a required bandwidth in step s62.

Meanwhile, when the device application receives a request for transmission of the next file, new information on a required bandwidth can also be used in renewing the information on the required bandwidth without deleting the previous information. Then, packets are transmitted in units of a data block, inclusive of information required for identification of an end packet, in step s64. Packets of a program other than the start packet or the end packet are transmitted in units of data blocks in step s70.

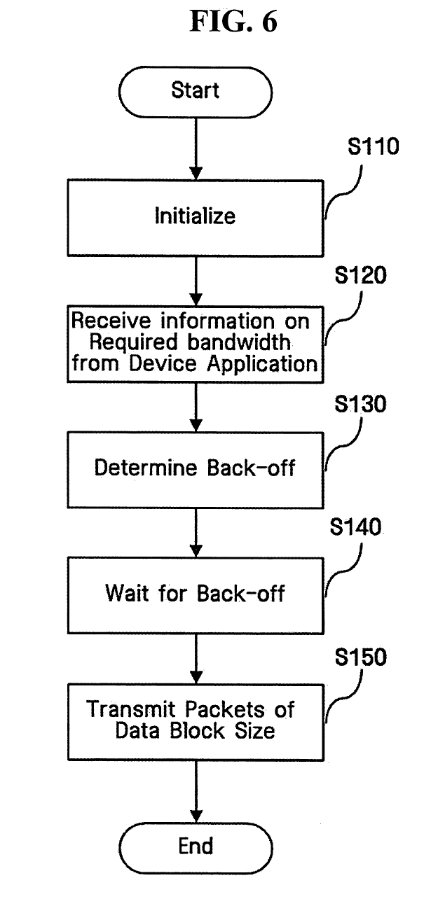

FIG. 6 is a flowchart showing a method used by a station in transmitting ordinary data according to an embodiment of the present invention. A decision whether to transmit real-time data or ordinary data is optionally made by each station. The decision may also be made according to whether a station transmits the data in a real-time transmission mode or an ordinary transmission mode.

First, a station that transmits ordinary data initializes a MAC in step S110. Information on a required bandwidth of a file to be transmitted is received from the device application in step s120. The MAC, which has received the information on the required bandwidth, determines a back-off based on the received information in step s130. The back-off of a station is determined by its own required bandwidth.

Otherwise, the back-off may be influenced by the type of data or required bandwidths of other stations. In a preferred embodiment of the present invention, information on a required bandwidth of other stations can also be used.

In step s140, when a channel is idle, the station waits for the back-off after the back-off is determined. Then, packets are transmitted in units of data blocks in step s150.

A station that transmits ordinary data doesn't store information on the required bandwidth because required bandwidths for the respective files are different from one another. In the present invention, the term “required bandwidth” is used to denote an average transmission speed as desired, which is a different concept from a transmission speed at which a predetermined level of QoS is ensured, which will now be explained in more detail.

For example, assuming that a 1 Mbit file is to be transmitted within 100 seconds, it can be said that ordinary data has a bandwidth of 100 kbps. That is, the required transmission speed is obtained by dividing the entire file size by the bandwidth.

On the contrary, a station that transmits streaming data having a bandwidth of 100 kbps must transmit the data at 100 kbps in a real-time mode in order to continuously transmit the data without intermittence. While the transmission speed of the streaming data may be slightly variable by using a buffer, a data transmission speed of 100 kbps is still required.

Next, a method of determining a back-off will be described. Prior to determination of the back-off, it is first determined whether data needs to be transmitted in a real-time transmission mode or not. For real-time data, it is important to get information on a required bandwidth. However, what is more important is to win in contentions a predetermined number of times per second through the back-off. Therefore, the back-off must be determined in such a manner that a priority is given to a station that transmits real-time data by reducing the back-off. It is also necessary to consider information on the required bandwidth. The back-off of the station that transmits real-time data and ordinary data may be determined by Equation 2 and Equation 3, respectively:
Tb(real-time data)=R(CW)×St [Equation 2]
where St indicates a temporal length of a time slot, and CW=f(a÷required bandwidth), in which “a” is a predetermined constant, and function f(a÷required bandwidth) is a minimum integer greater than a÷required bandwidth;
Tb(ordinary data)=(MCW+R(b))×St [Equation 3]
where MCW indicates the maximum value of Tb in Equation 2, and b=min (CW, CWmax), the CW being obtained using Equation 1.

When a station transmits real-time data, it is understood from Equations 2 and 3 that a back-off inversely proportionate to the size of the required bandwidth is given to the real-time data having a large required bandwidth. When a station transmits ordinary data, it is evident from the equations that a back-off longer than the maximum back-off of a station that transmits real-time data among stations constituting a BSS is given to the ordinary data. In other words, when there is no station that transmits real-time data, the station that transmits ordinary data has the same back-off as computed using Equation 1. Otherwise, when there is a station that transmits real-time data, the station that transmits ordinary data has a longer back-off than that of the station that transmits real-time data.

FIG. 7 shows a structure of the IEEE 802.11 MAC frame, and FIG. 8 is a table showing the types and subtypes of the MAC IEEE 802. 11 frame.

Referring to FIG. 7, a frame format of the present invention is the same as the conventional standard frame format. That is, the frame format includes a 2-byte frame control field, a 2-byte duration/ID, various 48-bit address fields ADDR1, ADDR2, and ADDR3, a 2-byte sequence control, a 6-byte address field ADDR4, a frame body of up to 2,312 bytes, and a 4-byte Frame Check Sequence (FCS).

The frame control field includes Protocol in which a protocol version, such as the 802.11 MAC version, is specified, Types and Subtypes for discriminating the type of a frame in use, and various fields in which various parameters for frame control are stored, including ToDS, FromDS, Additional Fragment, Retry, Power Management, Additional Data, Wired Equivalent Privacy (WEP), and Order. The types and subtypes of a frame are illustrated in FIG. 8.

The Duration/ID is used for various purposes in the form of one among a frame transmitted during a Network Allocation Vector (NAV) set period, a frame transmitted during a Contention Free Period (CFP), and a Power-Save (PS)-Poll message frame.

The respective address fields are used for storage of parameters for frame movement. Specifically, the address fields, labeled ADDR1, ADDR2 and ADDR3, are for use in receiving, transmitting and filtering operations performed by the receiver, respectively.

The sequence control field is used for reassembling fragments and discarding redundant frames, and includes a 4-bit fragment number field and a 12-bit sequence number field.

The frame body field, called a data field, supports a 2,312 byte frame body to accommodate an 8-byte overhead introduced by SEP of up to 2,304 byte data. The FCS filed is used to check the integrity of a frame received from a specific station.

Referring to FIG. 8, frames are largely classified into a management frame 00, a control frame 01, and a data frame 10. In addition, a reserved frame 11, which is not in use, may exist. The respective types of frames are discriminated from one another by a 4-bit subtype field value. For example, a frame having a subtype value of 1000 in the management frame 00 is a beacon frame. A frame having a subtype value of 1101 in the control frame 01 is an ACK frame, and a frame having a subtype value of 0000 in the data frame 10 is a data frame. As shown in FIG. 8, each frame has some reserved subtypes. The reserved subtypes can be determined in a vendor defined manner for implementation of a wireless LAN product, or can be used by an improved MAC. In fact, the IEEE 802.11e mechanism employs a number of reserved subtype frames, which are reserved in the 802.11. Representative reserved subtypes have values of 1000˜1111 used as data types for QoS.

In the illustrative embodiment of the present invention, in a case where the first station transmits data to the second station, the data containing information on a start or end packet of streaming data and information on a required bandwidth, the information contained in the data may be necessitated by stations other than the second station. In this case, one of the reserved subtype values can be selected to define a new frame. Even if the frame is not transmitted to each of the respective stations, the respective stations constituting a BSS can obtain their desired information, e.g., information on a start packet, an end packet or a required bandwidth, from a MAC header, due to the newly defined frame.

FIG. 9 shows various methods of transmitting frames by determining block sizes according to bandwidths.

For a frame which is not compliant with the standard type frame requirements, some required information is input to a header using a newly defined frame, so that a receiving station is able to obtain the information.

In the present invention, in order to ensure QoS of a transmitting station that transmits real-time data, a back-off of the transmitting station is made to be shorter than the other stations. Another way to ensure QoS is to increase the quantity of data transmitted, which will be described with reference to FIG. 9.

FIG. 9 shows various methods of transmitting frames of a data block size.

The DCF transmission mechanism can be modified according to characteristics of data in various manners. For example, the modification of the DCF transmission mechanism can be achieved by controlling a back-off, as described above. The modification of the DCF transmission mechanism can also be achieved by controlling the quantity of data transmitted during a single bout of transmission, which will now be described. Methods of transmitting frames of a data block size through one-time contention are performed in two ways. First, as shown in FIG. 9A, a Block Ack mechanism may be used without performing the set-up and end processes, unlike the conventional 802.11e. Rather than transmitting data continuously at a time, a station transmits just a predetermined quantity of data, that is, data corresponding to a data block size, and then the station is made to contend with other stations. Here, an Ack is made when all frames, e.g., 4 frames in FIG. 9A, are normally received. Or, the Ack can also be made when any one of the frames is received. In the former case, if any of the transmitted frames is broken, all of the four frames must be retransmitted. However, in the latter case, the broken frame has only to be retransmitted. To implement this mechanism, data should be transmitted through a new frame so that the Ack is not necessarily performed whenever transmission of each frame is made. With regard to the Ack, while the conventional Ack method may be used in the former case, a newly defined Ack frame must be used in the latter case.

FIG. 9B shows a frame transmission method, which does not conflict with the conventional standard at all, and is most preferred in consideration of compatibility with the standard mechanism. According to this method, four frames are transmitted and a time for an Ack is set to NAV. This method is employed in fragmentation and re-fragmentation transmission methods based on the 802.11 mechanism.

FIG. 9C shows a transmission method with a No Ack operation. In order to check whether a data frame is transmitted properly or not, the transmitting station may request for an Ack through a field created by a newly defined frame whenever necessary.

FIG. 9D shows a transmission method in which data of more than 2304 bytes, which is the maximum limit of a frame body, is transmitted using the newly defined frame.

The respective methods mentioned above are compared with one another from the viewpoint of their advantages and disadvantages. The method shown in FIG. 9B is preferred because data can be transmitted at a SIFS interval without having to modify the standard and waiting for DIFS and back-off durations. The method shown in FIG. 9A is also preferred because it is possible to check whether a data frame is transmitted normally or not and it is not necessary to perform the Ack in every transmission try. As a result, a high transmission efficiency is achieved. In this case, however, it is necessary to define a new frame and its procedure, which is troublesome. The method shown in FIG. 9C is possibly embodied in an ideal communication environment. In an actual noisy environment, however, it is quite difficult to achieve good transmission performance. Particularly, when a microwave oven operates, transmission performance becomes even worse. The method shown in FIG. 9D has a problem in that excessive data loss may occur when any frame is damaged during transmission. In order to achieve the highest transmission efficiency, there should be no transmission error. In a wireless LAN, however, since power of not greater than a predetermined level must be used in a non-allowed band, transmission errors unavoidably occur. As the length of a frame increases, the damage due to occurrence of transmission errors becomes more severe.

There are several methods for achieving good transmission performance, including changing a back-off determination method and adjusting the quantity of data transmitted at a time. These methods may be used independently or together. Transmission performance is presumably higher in the case of using the methods together than in the case of using the methods independently, and Table 1 table shows experimental data thereof.

Experimental conditions are shown below as defined in the IEEE 802.11a PHY values and Table 1 shows the experimental results thereof.

TABLE 1

| Mode | Modulation | Code Rate | Data Rate | bps |
|---|---|---|---|---|
| 1 | BPSK | ½ | 6 Mbps | 24 |
| 2 | BPSK | ¾ | 9 | 36 |
| 3 | QPSK | ½ | 12 | 48 |
| 4 | QPSK | ¾ | 18 | 54 |
| 5 | 16-QAM | ½ | 24 | 96 |
| 6 | 16-QAM | ¾ | 36 | 144 |
| 7 | 64-QAM | ⅔ | 48 | 192 |
| 8 | 64-QAM | ¾ | 54 | 216 |

Meanwhile, parameter values of the IEEE 802.11a OFDM PHY are shown in Table 2.

TABLE 2

| Characteristics | Value |
|---|---|
| aSlotTime | 9 μs |
| aSIFSTime | 16 μs |
| aCCATime | <4 μs |
| aRxTxTurnaroundTime | <2 μs |
| aTxPLCPDelay | Implementation dependent |
| aRxPLCPDelay | Implementation dependent |
| aRxTxSwitchTime | <<1 μs |
| aTxRampOnTime | Implementation dependent |
| aTxRampOffTime | Implementation dependent |
| aTxRFDelay | Implementation dependent |
| aRxRFDelay | Implementation dependent |
| aAirPropagationTime | <<1 μs |
| aMACProcessingDelay | <2 μs |
| aPreambleLength | 20 μs |
| aPLCPHeaderLength | 4 μs |
| aMPDUMaxLength | 4095 |
| aCWmin | 15 |
| aCWmax | 1023 |

The size of a payload of a data frame used is 1500 bytes that is the maximum size of an Ethernet packet. 54 Mbps is used as the PHY value, and it is assumed that there is no error in the channel environment. The method of FIG. 9A was used for an experiment, and Table 2 shows the calculation of the experiment.

TABLE 3

| | | | | Number of | Average | Increasing |
|---|---|---|---|---|---|---|
| | | | | Frames | Transmission | Rate in |
| | Type of | Range of | Average | Transmitted | Speed | Transmission |
| Station | Data | Back-off | Back-off | at a time | (Mbps) | (%) |
| 1 | Real-time | [0, 4] | 2 | 6 | 44.335 | 43.9 |
| 2 | Real-time | [0, 11] | 5.5 | 2 | 41.995 | 36.3 |
| 3 | General | [11, 18] | 9.5 | 3 | 42.883 | 39.2 |
| 4 | General | [11, 18] | 9.5 | 1 | 38.523 | 25.1 |

The back-off was calculated using Equation 2 and 3. The number of frames transmitted was in proportion to a required bandwidth. For convenient calculation of the back-off, the required bandwidth indicated was substituted with the number of frames transmitted at a time, and the constant “a” was set to 20. As evident from Table 3, the overall transmission rate increased. In particular, the transmission efficiency for real-time data was much higher than the other cases. Also, the average transmission speed became higher as the required bandwidth increased.

Having thus described certain embodiments of the present invention, various alterations, modifications and improvements will be apparent to those of ordinary skill in the art without departing from the spirit and scope of the present invention. Accordingly, the above-described embodiments are to be regarded in an illustrative rather than a restrictive sense in every respect, and all such modifications are intended to be included within the scope of the present invention and defined only in accordance with the following claims and their equivalents.

In wireless DCF mode communications according to the present invention, the data transmission efficiency can be enhanced while ensuring an appropriate level of QoS adaptively to characteristics of data transmitted. To this end, the present invention also provides a mechanism operable by minimally modifying the existing standard specification.

1. A wireless local area network (LAN) communication method, comprising:
(a) setting a predetermined back-off according to a characteristic of data transmitted; and
(b) transmitting data when a channel is available at the end of the back-off, and updating the back-off using residual back-off when a channel is used during the back-off.

2. The method of claim 1, wherein in step (a), the back-off is set using information on either a type of data transmitted or a required bandwidth.

3. The method of claim 1, wherein in step (a), different types of data have different equations for determining a back-off, and the information on the required bandwidth is used in the equations.

4. The method of claim 3, wherein the back-off for real-time data and the back-off for ordinary data are determined by the following equations, respectively:
Tb(real-time data)=R(CW)×St; and
Tb(ordinary data)=(MCW+R(b))×St
wherein St indicates the duration of one time slot, CW=f(a÷required bandwidth), “a” indicates a predetermined constant, function f(a÷required bandwidth) indicates a minimum integer greater than a÷required bandwidth, MCW indicates the maximum value of Tb obtained in the equation for real-time data, b=min (CW, CWmax), and CW indicates the size of a contention window.

5. The method of claim 1, wherein the characteristic of data transmitted is a required bandwidth for transmission, and step (b) further comprises determining a unit size of data to be transmitted according to the size of the required bandwidth.

6. The method of claim 5, wherein the unit size of data is in proportion to the required bandwidth.

7. The method of claim 6, wherein the number of frames transmitted at one time is determined by the unit size of data.

8. The method of claim 7, wherein when the number of frames transmitted at one time is at least two, the time taken to transmit all the frames is determined through a network allocation vector (NAV).

9. A wireless LAN communication method, comprising:
(a) determining a unit size of data transmitted according to a required bandwidth for transmission; and
(b) transmitting data corresponding to the unit size of data determined in step (a) when a channel is available at the end of a predetermined back-off, and updating the back-off using residual back-off when a channel is used during the back-off.

10. The method of claim 9, wherein the unit size of data is in proportion to the required bandwidth.

11. The method of claim 10, wherein the number of frames transmitted at one time is determined by the unit size of data.

12. The method of claim 11, wherein when the number of frames transmitted at one time is at least two, the time taken to transmit all the frames is determined through a network allocation vector (NAV).
